(19) United States
(12) Patent Application Publication
(10) Pub. No.: US 2025/0083311 A1
(43) Pub. Date: Mar. 13, 2025

(54) OPTIMIZATION MODELING AND ROBUST CONTROL METHOD FOR SOFT ROBOT BASED ON FUSION PREDICTION EQUATION

(71) Applicant: SOUTHEAST UNIVERSITY, Jiangsu (CN)

(72) Inventors: Baoguo XU, Jiangsu (CN); Jiajin WANG, Jiangsu (CN); Xin WANG, Jiangsu (CN); Weifeng PENG, Jiangsu (CN); Aiguo SONG, Jiangsu (CN)

(73) Assignee: SOUTHEAST UNIVERSITY, Jiangsu (CN)

(21) Appl. No.: 18/827,825

(22) Filed: Sep. 8, 2024

Related U.S. Application Data
(63) Continuation of application No. PCT/CN2023/127245, filed on Oct. 27, 2023.

(30) Foreign Application Priority Data
Sep. 11, 2023 (CN) 202311165388.6

(51) Int. Cl. B25J 9/16

(52) U.S. Cl. CPC B25J 9/163; B25J 9/161; B25J 9/1694

(57) ABSTRACT

Disclosed is an optimization modeling and robust control method for a soft robot based on a fusion prediction equation, including the following steps: deriving measurement coordinates based on the fusion prediction equation; designing an observation function based on the measurement coordinates; identifying a Koopman model based on the observation function; and designing a robust model predictive controller based on the Koopman model. Further disclosed are a fusion prediction equation and a derivation method thereof, which can derive correct, abundant but non-redundant measurement coordinates, overcoming the problem of single measurement coordinates in a soft robot system, thereby being conducive to simplifying a design process of the observation function and further improving the accuracy of the Koopman model for the soft robot.

### CROSS-REFERENCE TO RELATED APPLICATION

This application is a continuation of PCT application No. PCT/CN2023/127245, filed on Oct. 27, 2023, which claims a priority benefit to China patent application No. CN202311165388.6 filed on Sep. 11, 2023. The entirety of each of the above-mentioned patent applications is hereby incorporated by reference herein and made a part of this specification.

### TECHNICAL FIELD

The present disclosure belongs to the technical field of soft robot modeling and control, and particularly relates to an optimization modeling and robust control method for a soft robot based on a fusion prediction equation.

### BACKGROUND

Robotics plays a crucial role in manufacturing, healthcare, and service industries. Traditional manipulators excel in force output strength and kinematic accuracy, but are constrained by high rigidity materials and structures thereof, and are hard to cope with complex and variable environments. As a driving-sensing integrated device with highly elastic materials as a main body, soft robots have flourished in fields such as rescue missions, medical rehabilitation, and human-robot interaction with their inherent flexibility and adaptability, showing bright application prospects.

However, despite a great many of theoretical advantages of soft robots, precise modeling and control remain severe challenges. This is because: 1. flexible materials of soft robots exhibit complex hysteresis nonlinearity, making it extremely difficult to develop analysis models based on material properties and geometric structures; 2. soft robots are usually driven by fluids, while dynamic modeling requires solving complex fluid dynamics problems; and 3. Although the modeling is realized by considering complex nonlinearity of materials and driving mode, the modeling method is not universally applicable and is difficult to be adapted to soft robot systems with customized design. Furthermore, a complex form of the analysis model results in high computational costs, and cannot be applied to model-based real-time control technology. Consequently, most of the existing soft robots can only achieve rough motion functionality verification, but are difficult to be precisely controlled, limiting their practical applications.

Fortunately, a Koopman operator theory has proven that high-fidelity global linearization can be achieved by mapping nonlinear dynamics to a high-dimensional Koopman space through an observation function, and a mature linear control method can be applied to control complex nonlinear systems. Moreover, the linear control method is data-driven, avoiding the cumbersome process of analysis modeling, and can be adapted to the soft robot systems with customized design. At present, some publicly available technologies have applied the Koopman operator theory to the modeling and control of soft robots.

However, these technologies still face two problems to be solved:

1. No universal method for designing the observation function is available for Koopman modeling of soft robots. The quality of the observation functions directly affects the accuracy of a Koopman model, and the existing observation functions are usually selected based on empirical methods, which are costly to design and cannot guarantee the effects.

2. Control design based on the Koopman model usually adopts standard model predictive control, linear quadratic regulator, or other linear control methods, which exhibit poor robustness and are difficult to cope with parameter uncertainties and external disturbances.

### SUMMARY

In order to solve the above problems, the present disclosure provides an optimization modeling and robust control method for a soft robot based on a fusion prediction equation, which is used to solve an observation function design problem in the Koopman modeling of the soft robot, thereby improving the accuracy of the Koopman model, further realizing precise motion control of the soft robot, and enhancing the robustness of a control system.

In order to achieve the above objective, the present disclosure adopt the following technical solution:

an optimization modeling and robust control method for a soft robot based on a fusion prediction equation, including the following steps:
S1. deriving measurement coordinates based on the fusion prediction equation;
S2. designing an observation function based on the measurement coordinates;
S3. identifying a Koopman model based on the observation function; and
S4. designing a robust model predictive controller based on the Koopman model.

Further, the deriving measurement coordinates based on the fusion prediction equation in the step S1 specifically includes:

S11. deriving the fusion prediction equation; an objective of the fusion prediction equation is to obtain measurable variables that are closely related to the predicted controlled variables, which are used as measurement coordinates to design an observation function, so as to fully capture the system dynamics and improve the accuracy of Koopman modeling; and based on a concept of data fusion, the fusion prediction equation can achieve optimized prediction based on a plurality of assumption models, and is derived based on a general incremental equation:

$$θ ( k + 1 ) = θ ( k ) + Δ θ ( k + 1 )$$

where θ is a controlled variable, which is usually a bending degree or end position of the soft robot, the key to predicting θ(k+1) is to accurately estimate an incremental Δθ(k+1) of the controlled variable, and further, Δθ(k+1) is estimated based on the plurality of assumption models, and an assumption model 1 is a constant incremental model:

$$Δ {θ}_{1} ( k + 1 ) = Δ θ ( k ) = θ ( k ) - θ ( k - 1 )$$

where Δθ₁(k+1) is an incremental of controlled variables through a linear extrapolation based on the assumption model 1, the model assumes that the incremental of controlled variable is constant for each sampling period, and this constant velocity assumption over an entire range is only applicable to an extremely short sampling period or a system running smoothly;
relatively accurately, an assumption model 2 is a constant velocity assumption based on a single-step sampling period:

$$Δ {θ}_{2} ( k + 1 ) = T \dot{θ} ( k )$$

where \dot{θ}(k) is a differential of the controlled variable for a current sampling period, which can be estimated and obtained by using classical Kalman filter, unscented Kalman filter, or a tracking differentiator, and T is a sampling period, and assuming that the system moves at a constant velocity over the sampling period, an incremental estimate Δθ₂(k+1) of a second controlled variable can be obtained;
the foregoing two assumption models only reflect kinematic relationships without considering dynamics, and for a general soft robot system, input of the system does not have a strictly proportional relationship with the controlled variables, on this basis, an assumption model 3 is constructed:

$$Δ {θ}_{3} ( k + 1 ) = ε Δ u ( k ) = ε ( u ( k ) - u ( k - 1 ) )$$

where u is an input of the system, ε is a proportional coefficient, and the assumption model 3 assumes a positive proportional relationship between input and output of the system; and estimates from the three hypothetical models are not completely accurate, and the concept of data fusion can facilitate the implementation of improving the estimates:

$$Δ θ ( k + 1 ) = Δ {θ}_{1} ( k + 1 ) + α ( Δ {θ}_{2} ( k + 1 ) - Δ {θ}_{1} ( k + 1 ) ) + β ( Δ {θ}_{3} ( k + 1 ) - Δ {θ}_{1} ( k + 1 ) )$$

where α and β are weight parameters to be identified, and the incremental equation and the three hypothetical models are substituted into the above equation:

$$θ ( k + 1 ) = ( 2 - α - β ) θ ( k ) + ( α + β - 1 ) θ ( k - 1 ) + α T \dot{θ} ( k ) - β ε u ( k - 1 ) + β ε u ( k )$$

hysteresis coordinates are introduced and denoted as θ(k−1)=θ_{D}(k), u(k−1)=u_{D}(k), and a final fusion prediction equation is derived:

$$θ ( k + 1 ) = ( 2 - α - β ) θ ( k ) + ( α + β - 1 ) {θ}_{D} ( k ) + α T \dot{θ} ( k ) - β ε {u}_{D} ( k ) + β ε u ( k )$$

S12. deriving the measurement coordinates; and it is unnecessary to measure noise from the three hypothetical models to determine weight parameters in the fusion prediction equation, as the fusion prediction equation has already provided a set of variables closely related to the predicted controlled variables, which can be designed as measurement coordinates x in the Koopman modeling:

$$x [ k ] = {[ \begin{matrix}θ [ k ] & {θ}_{D} [ k ] & \dot{θ} [ k ] & {u}_{D} [ k ]\end{matrix} ]}^{T}$$

it should be noted that the present disclosure only illustrates the process of deriving the fusion prediction equations based on the three commonly used hypothetical models, but in practical operation, additional or modified hypothetical models can be introduced and the fusion prediction equations can be derived according to the specific characteristics and empirical behavior of the soft robot system, so as to derive correct, abundant but non-redundant measurement coordinates for customized soft robot systems.

Further, the designing an observation function based on the measurement coordinates in the step S2 specifically includes:
S21. designing an initial observation function based on the measurement coordinates; a set of high-dimensional nonlinear real-valued functions, that is, the initial observation function, is designed based on the measurement coordinates, and a form of the initial observation function can include monomials, polynomials, trigonometric functions, radial basis functions, and the like; and
S22. selecting the observation functions using a SINDy algorithm; a sparse identification of nonlinear dynamics (SINDy) algorithm is a publicly available data-driven technology for inferring a dominant term in dynamics, the algorithm is used to sparsely identify a dominant term in the initial observation function, and the dominant term is selected as a final observation function, such that dynamics of a nonlinear system with a lowest dimension can be fully captured.

The deriving measurement coordinates based on the fusion prediction equation in the step S1 and the designing an observation function based on the measurement coordinates in the step S2 together constitute a universal method to design observation functions for Koopman modeling of the soft robot, that is, designing the observation function based on the measurement coordinates derived from the fusion prediction equation, the method can replace traditional empirical design, fully capture the nonlinear dynamics of the system with the lowest dimension and minimal cost, and improve the accuracy of the Koopman model.

Further, the identifying a Koopman model based on the observation function in the step S3 specifically includes:

S31. performing data acquisition; where a large number of random measurement coordinate data pairs, in the form of (x[j], x[j+1]), j∈{1, 2, . . . , p}, are collected through experiments or simulations, and sorted out to obtain two matrices with one step evolution relationship:

$${X}_{1} = [ \begin{matrix}x [ 1 ] & x [ 2 ] & … & x [ p ]\end{matrix} ]$$

$${X}_{2} = [ \begin{matrix}x [ 2 ] & x [ 3 ] & … & x [ p + 1 ]\end{matrix} ]$$

S32. lifting data; where lifting data X₁ and X₂ are performed based on the observation function Ψ designed in the step S2:

$${X}_{1 lift} = [ \begin{matrix}Ψ ( x [ 1 ] & Ψ ( x [ 2 ] ) & … & Ψ ( x [ p ] ) ]\end{matrix}$$

$${X}_{2 lift} = [ \begin{matrix}Ψ ( x [ 2 ] & Ψ ( x [ 3 ] ) & … & Ψ ( x [ p + 1 ] ) ]\end{matrix}$$

an input term needs to be introduced, and X_{1lift} and X_{2lift} are further expanded to:

$${Y}_{1} = {[ \begin{matrix}{X}_{1 lift} & U\end{matrix} ]}^{T}$$

$${Y}_{2} = {[ \begin{matrix}{X}_{2 lift} & U\end{matrix} ]}^{T}$$

where U=[u[1] u[2] . . . u[p]] it should be noted that since evolution of the system input is not considered, a same input term needs to be expanded.

S33. Identifying the Koopman model; and the following objective function is minimized to obtain a finite-dimensional approximate representation of a Koopman operator \tilde{K}:

$$J = {‖ {Y}_{2} - \tilde{K} {Y}_{1} ‖}_{2}^{2}$$

a correlation matrix of the Koopman model is then isolated and divided from \tilde{K}:

$$\tilde{K} = [ \begin{matrix}{A}_{d} & {B}_{d} \\ O & I\end{matrix} ]$$

a mapping matrix C_{d}=[I O] is defined, and a control-oriented Koopman model is established for the soft robot system:

$${z}_{d} [ k + 1 ] = {A}_{d} {z}_{d} [ k ] + {B}_{d} u [ k ]$$

$$x [ k ] = {C}_{d} {z}_{c} [ k ]$$

where z_{d} is a state of the measurement coordinates x mapped to a high-dimensional Koopman space, and A_{d}, B_{d}, and C_{d} are matrix coefficients of the Koopman model.

Further, the designing a robust model predictive controller based on the Koopman model in the step S4 specifically includes:

S41. transforming into a Koopman incremental model; and the Koopman model identified in the step S3 is transformed into a Koopman incremental model by introducing an augmented state z:

$$z [ k + 1 ] = Az [ k [ + B Δ u [ k ]$$

$$x [ k ] = Cz [ k ]$$

where z[k]=[z_{d}[k] u[k−1]]^{T}, Δu[k]=u[k]−u[k−1], and the corresponding matrix coefficients are rewritten as: A=[_{O I}^{A}^{_{d}} ^{B}^{_{d}}], B=[B_{d} I]^{T}, and C=[C_{d} O]; and the model predictive controller is designed based on the Koopman incremental model, which adds an integral action to a closed-loop system, improving the robustness of the system.

S42. Designing dynamic constraints. A model predictive controller with dynamic constraints is designed based on the Koopman incremental model, and an improvement problem to be solved is:

$$\text{?} \text{?} ( {z [ k ]}^{T} Qz [ k ] + Δ {u [ k ]}^{T} R Δ u [ k ] ) + {z [ \text{?} ]}^{T} Fz [ \text{?} ]$$

$$s . t . z [ k + 1 ] = Az [ k ] + B Δ u [ k ] - g \leq Δ u [ k ] \leq g$$

$$\text{?} \text{indicates text missing or illegible when filed}$$

where Nₕ is a prediction horizon, Q, R and F are weight coefficients, g is dynamic constraint of Δu[k], g is always set to be positive and is dynamically adjusted based on the tracking performance of the system:

$$g = {k}_{g} e [ k ] + {b}_{g} \dot{e} [ k ]$$

$$e [ k ] = \vert \text{?} [ k ] - θ [ k ] \vert$$

$$\dot{e} [ k ] = \vert \text{?} [ k ] \vert - \vert \dot{θ} [ k ] \vert$$

$$\text{?} \text{indicates text missing or illegible when filed}$$

in the formula, k_{g} can be considered as a stiffness of the controller, which is proportional to a response speed; b_{g} can be considered as damping of the controller, which is conducive to reducing the system oscillations; and θᵣ is a reference value of the controlled variable for pre-tracking.

S43. improving and solving, and outputting control variables, the improvement problem is converted into a standard quadratic programming problem, and an optimal sequence of incremental of the control variables is solved under the dynamic constraints in each sampling period; and a first value of the optimal sequence of incremental of the control variables is finally selected and added to control variables of a previous sampling period to obtain optimal control variables for the current sampling period, and a solution process is repeated in the next sampling period.

The present disclosure has the beneficial effects:

1. The present disclosure provides a fusion prediction equation and a derivation method thereof, which can derive correct, abundant but non-redundant measurement coordinates, overcoming the problem of single measurement coordinates in soft robot system, thereby being conducive to simplifying the design process of observation function and further improving the accuracy of the Koopman model for the soft robot.

2. The observation function design method based on the fusion prediction equation in the present disclosure can fully capture dynamics of a nonlinear system with a lowest dimension, which is conducive to improving the accuracy of the Koopman model for the soft robot, and reducing the computation complexity of the controller. The method can completely replace traditional empirical design methods and is adaptable to the soft robot system with customized materials, structures and drives.

3. The present disclosure provides a robust model predictive controller based on the Koopman model, the controller adds an integral action to the closed-loop system, which can effectively enhance the robustness of the control system to handle parameter uncertainties and external disturbances. In addition, the controller dynamically adjusts constraints and solves the optimal control instructions according to the system performance, thereby significantly improving the dynamic and steady-state tracking performance of the system.

### BRIEF DESCRIPTION OF THE DRAWINGS

FIG. 1 is a flowchart of an optimization modeling and robust control method for a soft robot based on a fusion prediction equation according to the present disclosure.

FIG. 2 is a control block diagram of an optimization modeling and robust control method for a soft robot based on a fusion prediction equation according to the present disclosure applied to an actual soft robot system.

### DETAILED DESCRIPTIONS OF THE EMBODIMENTS

The present disclosure will be further illustrated below with reference to the accompanying drawings and specific embodiments. It should be understood that the following specific embodiments are only used to illustrate the present disclosure, but are not intended to limit the scope of the present disclosure.

### Embodiment 1

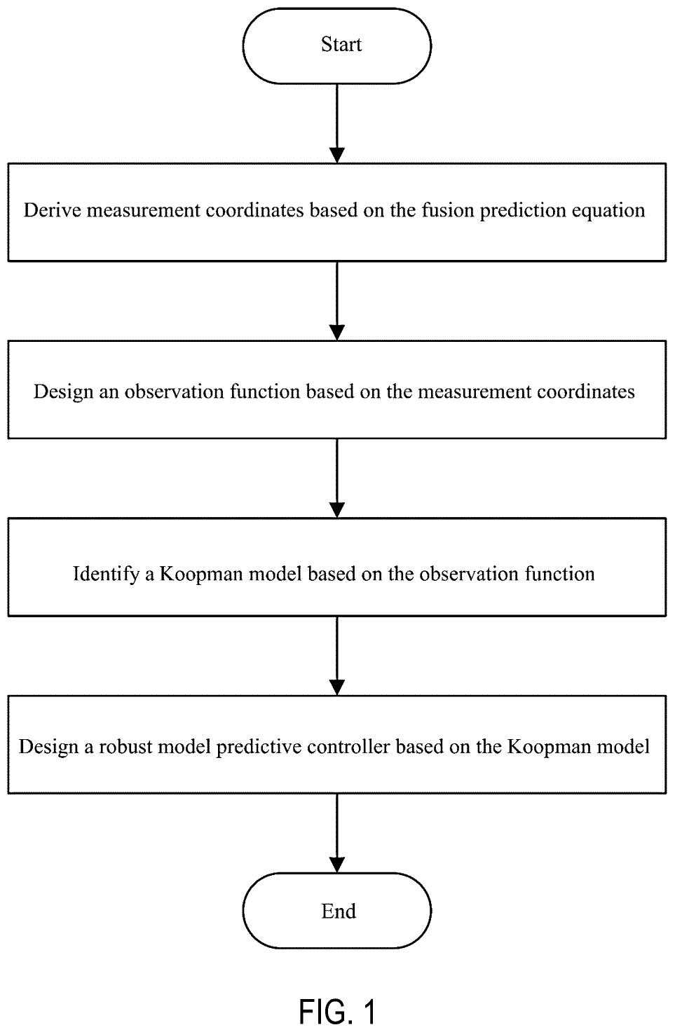

This embodiment describes specific implementation details of an optimization modeling and robust control method for a soft robot based on a fusion prediction equation, a flowchart of the method is shown in FIG. 1, and the method includes the following steps:

S1. derive measurement coordinates based on the fusion prediction equation, and this step specifically includes:

S11. derive the fusion prediction equation. An objective of the fusion prediction equation is to obtain measurable variables that are closely related to the predicted controlled variables, which are used as measurement coordinates to design an observation function, so as to fully capture the system dynamics and improve the accuracy of Koopman modeling. Based on a concept of data fusion, the fusion prediction equation can achieve optimized prediction based on a plurality of assumption models, and is derived based on a general incremental equation:

$$θ ( k + 1 ) = θ ( k ) + Δ θ ( k + 1 )$$

where θ is a controlled variable, which is usually a bending degree or end position of the soft robot. As can be seen from the above equation, the key to predicting θ(k+1) is to accurately estimate an incremental Δθ(k+1) of the controlled variable, and further, Δθ(k+1) is estimated based on the plurality of assumption models, and an assumption model 1 is a constant incremental model:

$$Δ {θ}_{1} ( k + 1 ) = Δ θ ( k ) = θ ( k ) - θ ( k - 1 )$$

where Δθ₁(k+1) is an incremental of controlled variables through a linear extrapolation based on the assumption model 1, the model assumes that the incremental of controlled variable is constant for each sampling period, and this constant velocity assumption over an entire range is only applicable to an extremely short sampling period or a system running smoothly. Relatively accurately, an assumption model 2 is a constant velocity assumption based on a single-step sampling period:

$$Δ {θ}_{2} ( k + 1 ) = T \dot{θ} ( k )$$

where \dot{θ}(k) is a differential of the controlled variable for a current sampling period, which can be estimated and obtained by using classical Kalman filter, unscented Kalman filter, or a tracking differentiator, and Tis a sampling period. Assuming that the system moves at a constant velocity over the sampling period, an incremental estimate of a second controlled variable Δθ₂(k+1) can be obtained. The foregoing two assumption models only reflect kinematic relationships without considering dynamics. For a general soft robot system, such as a fluid-driven soft robot, input of the system does not have a strictly proportional relationship with the controlled variables, on this basis, an assumption model 3 is constructed:

$$Δ {θ}_{3} ( k + 1 ) = ε Δ u ( k ) = ε ( u ( k ) - u ( k - 1 ) )$$

where u is an input of the system, ε is a proportional coefficient, and the assumption model 3 assumes a positive proportional relationship between input and output of the system. It should be noted that estimates from the three hypothetical models are not completely accurate, and have their respective application scenarios, but the concept of data fusion can facilitate the implementation of improving the estimates:

$$Δ θ ( k + 1 ) = Δ {θ}_{1} ( k + 1 ) + α ( Δ {θ}_{2} ( k + 1 ) - Δ {θ}_{1} ( k + 1 ) ) + β ( Δ {θ}_{3} ( k + 1 ) - Δ {θ}_{1} ( k + 1 ) )$$

where α and β are weight parameters to be identified.

The incremental equation and the three hypothetical models are substituted into the above equation:

$$θ ( k + 1 ) = ( 2 - α - β ) θ ( k ) + ( α + β - 1 ) θ ( k - 1 ) + α T \dot{θ} ( k ) - β ε u ( k - 1 ) + β ε u ( k )$$

hysteresis coordinates are introduced and denoted as θ(k−1)=θ_{D}(k), u(k−1)=u_{D}(k), and a final fusion prediction equation is derived:

$$0 ( k + 1 ) = ( 2 - α - β ) θ ( k ) + ( α + β - 1 ) {θ}_{D} ( k ) + α T \dot{θ} ( k ) - β ε {u}_{D} ( k ) + β ε u ( k )$$

S12. derive the measurement coordinates. In order to realize the prediction of the controlled variables, the fusion prediction equation makes full use of a current controlled variable, a time-delay controlled variable, a differential of the current controlled variable, a time-delay input and a current input. In fact, it is unnecessary to measure noise from the three hypothetical models to determine weight parameters in the fusion prediction equation, as the fusion prediction equation has already provided a set of variables closely related to the predicted controlled variables, which can be designed as measurement coordinates x in the Koopman modeling:

$$x [ k ] = {[ θ [ k ] {θ}_{D} [ k ] \dot{θ} [ k ] {u}_{D} [ k ] ]}^{T}$$

It should be noted that this embodiment only illustrates the process of deriving the fusion prediction equations based on the three commonly used hypothetical models. In practical operation, additional or modified hypothetical models can be introduced and the fusion prediction equations can be derived according to the specific characteristics and empirical behavior of the soft robot system, so as to derive correct, abundant but non-redundant measurement coordinates for different soft robot systems.

S2. Design an observation function based on the measurement coordinates, and this step specifically includes:

S21. design an initial observation function based on the measurement coordinates. A set of high-dimensional nonlinear real-valued functions, that is, the initial observation function, is designed based on the measurement coordinates, and a form of the initial observation function can include monomials, polynomials, trigonometric functions, radial basis functions, and the like. The initial observation function captures almost all the dynamics of a nonlinear system due to its high-dimensional characteristics and rich measurement coordinates, but the high-dimensional characteristics will greatly increase the computational complexity of subsequent identification and optimal control of the Koopman model.

S22. Select the observation functions using a SINDy algorithm. A sparse identification of nonlinear dynamics (SINDy) algorithm is a publicly available data-driven technology for inferring a dominant term in dynamics, the algorithm is used to sparsely identify a dominant term in the initial observation function, and the dominant term is selected as a final observation function, such that dynamics of a nonlinear system with a lowest dimension can be fully captured.

Derive measurement coordinates based on the fusion prediction equation in the step S1 and design an observation function based on the measurement coordinates in the step S2 together constitute a universal method to design observation functions for Koopman modeling of the soft robot, that is, designing the observation function based on the measurement coordinates derived from the fusion prediction equation, the method can replace traditional empirical design, fully capture the nonlinear dynamics of the system with the lowest dimension and minimal cost, improve the accuracy of the Koopman model, and reduce the complexity of an optimal control solution, and furthermore, the data-driven form makes the Koopman modeling adaptable to the soft robot system with customized materials, structures and drives.

S3. Identify a Koopman model based on the observation function, and this step specifically includes:

S31. perform data acquisition. A large number of data pairs of random measurement coordinates, in the form of (x[j], x[j+1]) j∈{1, 2, . . . , p}, are collected through experiments or simulations, and sorted out to obtain two matrices with one step evolution relationship:

$${X}_{1} = [ x [ 1 ] x [ 2 ] … x [ p ] ] \\ {X}_{2} = [ x [ 2 ] x [ 3 ] … x [ p + 1 ] ]$$

S32. lift data, lifting data X₁ and X₂ are performed based on the observation function Ψ designed in the step S2:

$${X}_{1 lift} = [ Ψ ( x [ 1 ] ) Ψ ( x [ 2 ] ) … Ψ ( x [ p ] ) \\ {X}_{2 lift} = [ Ψ ( x [ 2 ] ) Ψ ( x [ 3 ] ) … Ψ ( x [ p + 1 ] )$$

Further, considering that the soft robot system is a controlled system, an input term needs to be introduced, and X_{1lift}, and X_{2lift} are further expanded to:

$${{Y}_{{1}^{=}} [ {X}_{1 lift} U ]}^{T} \\ {{Y}_{{2}^{=}} [ {X}_{2 lift} U ]}^{T}$$

where U=[u[1] u[2] . . . [p]], it should be noted that since evolution of the system input is not considered, a same input term needs to be expanded.

S33. Identify the Koopman model. The following objective function is minimized using machine learning algorithms such as a least squares method, and a particle swarm improvement, to obtain a finite-dimensional approximate representation of a Koopman operator \tilde{K}:

$$J = {‖ {Y}_{2} - \tilde{K} {Y}_{1} ‖}_{2}^{2}$$

Further, a correlation matrix of the Koopman model is isolated and divided from \tilde{K}:

$$\tilde{K} = [ \begin{matrix}{A}_{d} & {B}_{d} \\ O & I\end{matrix} ]$$

A mapping matrix C_{d}=[I O] is defined.

Finally, a control-oriented Koopman model is established for the soft robot system.

$${z}_{d} [ k + 1 ] = {A}_{d} {z}_{d} [ k ] + {B}_{d} u [ k ] \\ x [ k ] = {C}_{d} {z}_{d} [ k ]$$

where z_{d} is a state of the measurement coordinates x mapped to a high-dimensional Koopman space, and A_{d}, B_{d}, and C_{d} are matrix coefficients of the Koopman model.

S4. Design a robust model predictive controller based on the Koopman model, and this step specifically includes:

S41. transform into a Koopman incremental model. The Koopman model identified in the step S3 is transformed into a Koopman incremental model by introducing an augmented state Z.

$$z [ k + 1 ] = Az [ k ] + B Δ u [ k ] \\ x [ k ] = Cz [ k ]$$

where z[k]=[z_{d}[k] u[k−1]]^{T}, Δu[k]=u[k]−u[k−1], and the corresponding matrix coefficients are rewritten as:

$$A = [ \begin{matrix}{A}_{d} & {B}_{d} \\ O & I\end{matrix} ]$$

B=[B_{d} I]^{T}, and C=[C_{d} O]; and the model predictive controller is designed based on the Koopman incremental model, which adds an integral action to a closed-loop system, improving the robustness of the system.

S42. Design dynamic constraints. A model predictive controller with dynamic constraints is designed based on the Koopman incremental model, and an improvement problem to be solved is:

$$\begin{matrix}{min}_{z [ k ] , Δ u [ k ]} {\sum }_{k = 0}^{{N}_{h} - 1} ( {x [ k ]}^{T} Qz [ k ] + Δ {u [ k ]}^{T} R Δ u [ k ] ) + {z [ {N}_{h} ]}^{T} Fz [ {N}_{h} ] \\ s . t . z [ k + 1 ] = Az [ k ] + B Δ u [ k ] \\ - g \leq Δ u [ k ] \leq g\end{matrix}$$

where Nₕ is a prediction horizon, Q, R and F are weight coefficients, g is dynamic constraint of Δu[k], g is always set to a positive value, allowing its value to balance dynamic and steady-state performance of the system. A larger value of g allows considerable changes in the control increment, which is conducive to improving a response speed, however, it is also easy to cause system oscillations in a steady state; in contrast, a smaller value of g helps reduce steady-state oscillations but results in slower response. Therefore, inspired by a concept of impedance control, the value of g is always set to be positive and is dynamically adjusted based on the tracking performance of the system, so as to improve both the dynamic and steady-state performance of the system.

$$g = {k}_{g} e [ k ] + {b}_{g} \dot{e} [ k ] \\ e [ k ] = \vert {θ}_{r} [ k ] - θ [ k ] \vert \\ \dot{e} [ k ] = \vert {\dot{θ}}_{r} [ k ] \vert - \vert \dot{θ} [ k ] \vert$$

specifically, k_{g} can be considered as a stiffness of the controller, which is proportional to a response speed; b_{g} can be considered as damping of the controller, which is conducive to reducing the system oscillations; and θᵣ is a reference value of the controlled variable for pre-tracking.

S43. Improve and solve, and output control variables The above improvement problem is converted into a standard quadratic programming problem by adopting basic reasoning methods such as linear extrapolation, and an optimal sequence of incremental of the control variables is solved under the dynamic constraints in each sampling period. Further, a first value of the optimal sequence of incremental of the control variables is finally selected and added to control variables of a previous sampling period to obtain optimal control variables for the current sampling period, and a solution process is repeated in the next sampling period.

### Embodiment 2

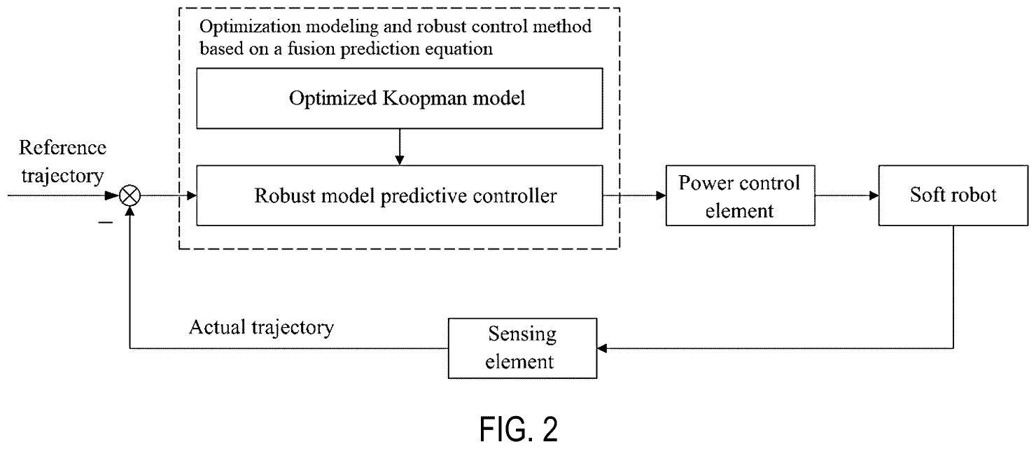

This embodiment describes a specific implementation structure of an optimization modeling and robust control method for a soft robot based on a fusion prediction equation in practical applications. With reference to FIG. 2, FIG. 2 illustrates a control block diagram for applying the optimization modeling and robust control method for a soft robot based on a fusion prediction equation to an actual soft robot system, including an optimized Koopman model, a robust model predictive controller, a power control element, a soft robot, and a sensing element. Advantages of the optimized Koopman model includes: deriving correct, abundant but non-redundant measurement coordinates based on the fusion prediction equation, selecting the observation function capable of capturing dynamics of the system with the lowest dimension using an SINDy algorithm, performing Koopman modeling based on the observation function, and improving the accuracy of the Koopman model of the soft robot based on the observation function. The robust model predictive controller is designed based on the optimized Koopman model, and adds the integral action to the closed-loop system, adjusts constraints dynamically based on the tracking performance of the system, solves an optimal control instruction and sends the same to the power control element, where the common power control element includes electrical proportional valves, flow valves, motors, and the like, and a type of the power control element depends on a driving method of the soft robot; the power control element transmits power and drives the soft robot to achieve preset motions or behaviors; and the sensing element is configured to measure kinematic or mechanical signals of the soft robot, including bending angle, end position, end output force, output torque, and the like, and feeds back the signals to the robust model predictive controller, forming a closed-loop control system for the soft robot.

It should be noted that the above content merely illustrates the technical idea of the present disclosure and cannot limit the protection scope of the present disclosure, those ordinarily skilled in the art may also make some modifications and improvements without departing from the principle of the present disclosure, and these modifications and improvements should also fall within the protection scope of the claims of the present disclosure.

What is claimed is:

1. An optimization modeling and robust control method for a soft robot based on a fusion prediction equation, comprising the following steps:
S1. deriving measurement coordinates based on the fusion prediction equation;
S2. designing an observation function based on the measurement coordinates;
S3. identifying a Koopman model based on the observation function; and
S4. designing a robust model predictive controller based on the Koopman model.

2. The optimization modeling and robust control method for a soft robot based on a fusion prediction equation according to claim 1, wherein the deriving measurement coordinates based on the fusion prediction equation in the step S1 specifically comprises:
S11. deriving the fusion prediction equation, wherein the fusion prediction equation is optimized prediction based on a plurality of assumption models, and is derived based on a general incremental equation:
$$θ ( k + 1 ) = θ ( k ) + Δθ ( k + 1 )$$
wherein θ is a bending degree or end position of the soft robot as a controlled variable, θ(k+1) is an incremental of the controlled variable, and further, Δθ(k+1) is estimated based on the plurality of assumption models, and an assumption model 1 is a constant incremental model:
$${Δθ}_{1} ( k + 1 ) = Δθ ( k ) = θ ( k ) - θ ( k - 1 )$$
wherein Δθ₁(k+1) is an incremental of controlled variables through a linear extrapolation based on the assumption model 1, the model assumes that the incremental of controlled variable is constant for each sampling period, and this constant velocity assumption over an entire range is only applicable to an extremely short sampling period or a system running smoothly;
wherein an assumption model 2 is a constant velocity assumption based on a single-step sampling period:
$${Δθ}_{2} ( k + 1 ) = T \dot{θ} ( k )$$
wherein \dot{θ}(k) is a differential of the controlled variable for a current sampling period, which can be estimated and obtained by using a tracking differentiator, and Tis a sampling period, and assuming that the system moves at a constant velocity over the sampling period, an incremental estimate Δθ₂(k+1) of a second controlled variable can be obtained;
the assumption model 1 and the assumption model 2 only reflect kinematic relationships without considering dynamics, and for a general soft robot system, input of the system does not have a strictly proportional relationship with the controlled variables, on this basis, an assumption model 3 is constructed:
$${Δθ}_{3} ( k + 1 ) = εΔ u ( k ) = ε ( u ( k ) - u ( k - 1 ) )$$
wherein u is an input of the system, ε is a proportional coefficient, and the assumption model 3 assumes a positive proportional relationship between input and output of the system; and estimates from the three hypothetical models are not completely accurate, and the concept of data fusion can facilitate the implementation of improving the estimates:
$$Δθ ( k + 1 ) = Δ {θ}_{1} ( k + 1 ) + α ( Δ {θ}_{2} ( k + 1 ) - Δ {θ}_{1} ( k + 1 ) ) + β ( {Δθ}_{3} ( k + 1 ) - Δ {θ}_{1} ( k + 1 ) )$$
wherein α and β are weight parameters to be identified, and the incremental equation and the three hypothetical models are substituted into the above equation:
$$θ ( k + 1 ) = ( 2 - α - β ) θ ( k ) + ( α + β - 1 ) θ ( k - 1 ) + α T \dot{θ} ( k ) - β ε u ( k - 1 ) + β ε u ( k )$$
hysteresis coordinates are introduced and denoted as θ(k−1)=θ_{D}(k), u(k−₁)=u_{D}(k), and a final fusion prediction equation is derived:
$$θ ( k + 1 ) = ( 2 - α - β ) θ ( k ) + ( α + β - 1 ) {θ}_{D} ( k ) + α T \dot{θ} ( k ) - β ε {u}_{D} ( k ) + β ε u ( k )$$
S12. deriving the measurement coordinates; and it is unnecessary to measure noise from the three hypothetical models to determine weight parameters in the fusion prediction equation, as the fusion prediction equation has already provided a set of variables closely related to predicted controlled variables, which can be designed as measurement coordinates x in Koopman modeling:
$$x [ k ] = {[ \begin{matrix}θ [ k ] & {θ}_{D} [ k ] & \dot{θ} [ k ] & {u}_{D} [ k ]\end{matrix} ]}^{T} .$$

3. The optimization modeling and robust control method for a soft robot based on a fusion prediction equation according to claim 1, wherein the designing an observation function based on the measurement coordinates in the step S2 comprises:
S21. designing an initial observation function based on the measurement coordinates; and a set of high-dimensional nonlinear real-valued functions, that is, the initial observation function, is designed based on the measurement coordinates, and a form of the initial observation function can comprise monomials, polynomials, trigonometric functions, and radial basis functions;
S22. selecting the observation functions using a SINDy algorithm; and the algorithm is used to sparsely identify a dominant term in the initial observation function, and the dominant term is selected as a final observation function, such that dynamics of a nonlinear system with a lowest dimension can be fully captured; and
the deriving measurement coordinates based on the fusion prediction equation in the step S1 and the designing an observation function based on the measurement coordinates in the step S2 together constitute a universal method to design observation functions for the Koopman modeling of the soft robot, that is, designing the observation function based on the measurement coordinates derived from the fusion prediction equation.

4. The optimization modeling and robust control method for a soft robot based on a fusion prediction equation according to claim 1, wherein the identifying a Koopman model based on the observation function in the step S3 specifically comprises:
S31. performing data acquisition; wherein a large number of random measurement coordinate data pairs are collected through experiments or simulations, and sorted out to obtain two matrices with one step evolution relationship:
$${X}_{1} = [ \begin{matrix}x [ 1 ] & x [ 2 ] & … & x [ p ]\end{matrix} ]$$
$${X}_{2} = [ \begin{matrix}x [ 2 ] & x [ 3 ] & … & x [ p + 1 ]\end{matrix} ]$$
S32. lifting data; wherein lifting data X₁ and X₂ are performed based on the observation function Ψ designed in the step S2:
$$\text{?} = [ \begin{matrix}Ψ ( x [ 1 ] ) & Ψ ( x [ 2 ] ) & … & Ψ ( x [ p ] )\end{matrix} ]$$
$${X}_{2 lift} = [ \begin{matrix}Ψ ( x [ 2 ] ) & Ψ ( x [ 3 ] ) & … & Ψ ( x [ p + 1 ] )\end{matrix} ]$$
$$\text{?} \text{indicates text missing or illegible when filed}$$
an input term needs to be introduced, and X_{1lift} and X_{2lift} are further expanded to:
$${Y}_{1} = {[ \begin{matrix}\text{?} & U\end{matrix} ]}^{T}$$
$${Y}_{2} = {[ \begin{matrix}{X}_{2 lift} & U\end{matrix} ]}^{T}$$
$$\text{?} \text{indicates text missing or illegible when filed}$$
wherein U=[u[1] u[2] . . . u[p]], it should be noted that since evolution of the system input is not considered, a same input term needs to be expanded;
S33. identifying the Koopman model; and the following objective function is minimized to obtain a finite-dimensional approximate representation of a Koopman operator \tilde{K}:
$$J = {‖ {Y}_{2} - \tilde{K} {Y}_{1} ‖}_{2}^{2}$$
a correlation matrix of the Koopman model is then isolated and divided from \tilde{K}:
$$\tilde{K} = [ \begin{matrix}{A}_{d} & {B}_{d} \\ O & I\end{matrix} ]$$
a mapping matrix C_{d}=[I O] is defined, and a control-oriented Koopman model is established for the soft robot system:
$${z}_{d} [ k + 1 ] = {A}_{d} {z}_{d} [ k ] + {B}_{d} u [ k ]$$
$$x [ k ] = {C}_{d} {z}_{d} [ k ]$$
wherein z_{d} is a state of the measurement coordinates x mapped to a high-dimensional Koopman space, and A_{d}, B_{d}, and C_{d} are matrix coefficients of the Koopman model.

5. The optimization modeling and robust control method for a soft robot based on a fusion prediction equation according to claim 1, wherein the designing a robust model predictive controller based on the Koopman model in the step S4 comprises:
S41. transforming into a Koopman incremental model; wherein the Koopman model identified in the step S3 is transformed into a Koopman incremental model by introducing an augmented state z:
$$z [ k + 1 ] = Az [ k ] + B Δ u [ k ]$$
$$x [ k ] = Cz [ k ]$$
wherein z[k]=[z_{d}[k] u[k−1]]^{T}, Δu[k]=u[k]−u[k−1], and the corresponding matrix coefficients are rewritten as:
$$A = [ \begin{matrix}{A}_{d} & {B}_{d} \\ O & I\end{matrix} ] ,$$
B=[B_{d} I]^{T}, and C=[C_{d} O]; and the model predictive controller is designed based on the Koopman incremental model, which adds an integral action to a closed-loop system, improving the robustness of the system;
S42. designing dynamic constraints, wherein the model predictive controller with dynamic constraints is designed based on the Koopman incremental model, and an improvement problem to be solved is:
$$\text{?} \text{?} ( {z [ k ]}^{T} Qz [ k ] + Δ {u [ k ]}^{T} R Δ u [ k ] ) + {z [ \text{?} ]}^{T} Fz [ \text{?} ]$$
$$s . t . z [ k + 1 ] = Az [ k ] + B Δ u [ k ] - g \leq Δ u [ k ] \leq g$$
$$\text{?} \text{indicates text missing or illegible when filed}$$
wherein Nₕ is a prediction horizon, Q, R and F are weight coefficients, g is dynamic constraint of Δu[k], g is always set to be positive and is dynamically adjusted based on the tracking performance of the system:
$$g = {k}_{g} e [ k ] + {b}_{g} \dot{e} [ k ]$$
$$e [ k ] = \vert {θ}_{r} [ k ] - θ [ k ] \vert$$
$$\dot{e} [ k ] = \vert {\dot{θ}}_{r} [ k ] \vert - \vert \dot{θ} [ k ] \vert$$
wherein k_{g} can be considered as a stiffness of the controller, which is proportional to a response speed; b_{g} can be considered as damping of the controller, which is conducive to reducing system oscillations; and θᵣ is a reference value of the controlled variable for pre-tracking; and
S43. improving and solving, and outputting control variables, the improvement problem is converted into a standard quadratic programming problem, and an optimal sequence of incremental of the control variables is solved under the dynamic constraints in each sampling period; and a first value of the optimal sequence of incremental of the control variables is finally selected and added to control variables of a previous sampling period to obtain optimal control variables for the current sampling period, and a solution process is repeated in the next sampling period.

6. A specific implementation structure of the optimization modeling and robust control method for a soft robot based on a fusion prediction equation in practical applications according to claim 1, comprising an optimized Koopman model, a robust model predictive controller, a power control element, a soft robot, and a sensing element, wherein the optimized Koopman model is capable of deriving correct, abundant but non-redundant measurement coordinates based on the fusion prediction equation, selecting the observation function capable of capturing dynamics of the system with the lowest dimension using an SINDy algorithm, performing Koopman modeling based on the observation function, and improving the accuracy of the Koopman model of the soft robot based on the observation function; the robust model predictive controller is designed based on the optimized Koopman model, and adds the integral action to the closed-loop system, adjusts constraints dynamically based on the tracking performance of the system, solves an optimal control instruction and sends the same to the power control element; and the power control element transmits power and drives the soft robot to achieve preset motions or behaviors; and the sensing element is configured to measure kinematic or mechanical signals of the soft robot, comprising bending angle, end position, end output force, and output torque, and feeds back the signals to the robust model predictive controller, forming a closed-loop control system for the soft robot.
